(19) United States
(12) Patent Application Publication
(10) Pub. No.: US 2026/0348921 A1
(43) Pub. Date: Nov. 5, 2026

(54) METHOD FOR DETECTING VIBRATION ANOMALIES USING AN EVENT CAMERA

(71) Applicant: Schlumberger Technology Corporation, Sugar Land, TX (US)

(72) Inventors: Ajit Mutalik, Houston, TX (US); Juan Alvarez, Houston, TX (US); Edward Gutierrez, SR., Houston, TX (US); Matthew Worthington, Houston, TX (US); Bernard Van Haecke, Menlo Park, CA (US)

(21) Appl. No.: 19/197,102

(22) Filed: May 2, 2025

(51) Int. Cl. G01N 29/06; G01N 29/44; G01N 29/46

(52) U.S. Cl. CPC G01N 29/069; G01N 29/0645; G01N 29/4427; G01N 29/4463; G01N 29/46

(57) ABSTRACT

A method for determining equipment status and detecting faults through vibration measurements over time at a site. The method includes generating first image data from an event camera event stream disposed at the site, synchronizing a frame from the first image data with a frame from the second image data, and then detecting a change at the site based on the first and second synchronized frames. Distortions from either the first or second image data received and extrinsic calibration parameters present between the event camera and the intensity-based camera may also be removed. The first synchronized frame may then be projected onto the second synchronized frame to generate a fused image which may then displayed on a screen.

### BACKGROUND

When operating a wellsite, a large amount of wellsite equipment may be used. This equipment may be monitored and maintained so that mechanical failures are kept to a minimum, thereby minimizing non-productive time at the wellsite. Frequently, the first sign that wellsite equipment may be beginning to fail are new or different vibrational readings emanating from the wellsite equipment.

Previously, part of the maintenance process for the wellsite equipment has been the use of point-based sensors such as vibrational sensors which may inform a user or manager of a change of vibrational behavior within that specific piece of wellsite equipment. It is well known that vibration data may help in monitoring baselines or trends of a particular piece of equipment's health and provide an early warning of potential faults and dangers. For example, a change in the vibration of the wellsite equipment may indicate an imbalance, a misalignment, looseness, or a faulty bearing within the equipment which may otherwise be difficult to detect. Vibration sensors may allow for the deployment of pro-active maintenance strategies, optimize the performance of an asset, increase a wellsite productive time, and enhance safety. However, point-based vibrational sensors and their associated monitoring and maintenance may be expensive and difficult to implement.

What is needed is a new method for monitoring changes in vibrational behavior within wellsite equipment which is easy to implement and which does not involve an expensive modification of the wellsite equipment itself, thereby providing a means for advanced monitoring of wellsite equipment which may lead to a reduction in non-productive time.

### SUMMARY

Disclosed are methods, systems, and computer programs for detecting vibration anomalies using an event camera. The method includes generating first image data from an event camera event stream disposed at a site, receiving image data from an intensity-based camera disposed at the site, and then synchronizing a frame from the event camera image data with a frame from the intensity-based camera image data. A change at the site may then be detected based on the synched event image data and intensity-based image data. The synched event frame may be projected onto the intensity-based frame to generate a fused image which may then be displayed on a screen.

According to certain embodiments, a computing system having one or more processors and a memory system may be provided. The memory system may include one or more non-transitory computer-readable media storing instructions that, when executed by at least one of the one or more processors, cause the computing system to perform operations, the operations. In certain embodiments, the operations include generating first image data from an event camera event stream disposed at the site, receiving image data from an intensity-based camera disposed at the site, and then synchronizing a frame from the event image data with a frame from the intensity-based image data. A change at the site may be detected that is based on the synched event image data and the intensity-based image data. The synched event frame may be projected onto the intensity-based frame to generate a fused image which may then be displayed on a screen.

According to certain embodiments, a non-transitory computer-readable medium storing instructions that, when executed by one or more processors of a computing system, cause the computing system to perform operations is provided. In certain embodiments, the operations may include generating first image data from an event camera event stream disposed at the site, receiving image data from an intensity-based camera disposed at the site, and then synchronizing a frame from the event image data with a frame from the intensity-based image data. A change at the site may be detected that is based on the synched event image data and intensity-based image data. The synched event frame may be projected onto the intensity-based frame to generate a fused image which may then be displayed on a screen.

### BRIEF DESCRIPTION OF THE DRAWINGS

The disclosure is illustrated by way of example, and not by way of limitation in the figures of the accompanying drawings in which like reference numerals are used to refer to similar elements. It is appreciated that various features may not be drawn to scale, and the dimensions of various features may be arbitrarily increased or reduced for clarity of discussion. Further, it is contemplated that features of one or more embodiments may be incorporated in other embodiments without additional recitation.

FIG. 1 illustrates an example of a system that includes various management components to manage various aspects of a geologic environment, according to an embodiment.

FIG. 2A illustrates a flowchart for providing a fused image from an image frame from an intensity-based camera and an image frame from an event camera, according to an embodiment.

FIG. 2B illustrates a flowchart for acquiring data from an intensity-based camera and from an event camera, according to an embodiment.

FIG. 2C illustrates a flowchart for fusing data from an intensity-based camera and from an event camera, according to an embodiment.

FIG. 3A illustrates exemplary object detection from image data received from an intensity-based camera, according to an embodiment.

FIG. 3B illustrates exemplary object detection from event data received from an event camera, according to an embodiment.

FIG. 4 illustrates exemplary extrinsic calibration of data received from an intensity-based camera and an event camera, according to an embodiment.

FIG. 5 illustrates a display showing exemplary vibration detection within event data received from an event camera, according to an embodiment.

FIG. 6 illustrates a flowchart of a method for determining equipment status and detecting faults through vibration measurements over time at a wellsite, according to an embodiment.

FIG. 7 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosed technology. However, it will be apparent to one of ordinary skill in the art that the disclosed embodiments may be practiced without these specific details. In other instances, well-known methods, procedures, components, circuits, and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the disclosure. The first object or step, and the second object or step, are both objects or steps, respectively, but they are not to be considered the same object or step.

The terminology used in the description of the disclosed techniques is for the purpose of describing particular embodiments and is not intended to be limiting. As used in the description of this disclosure and the appended claims, the singular forms “a,” “an” and “the” are intended to include the plural forms as well, unless the context clearly indicates otherwise. It will also be understood that the term “and/or” as used herein refers to and encompasses any combination of one or more of the associated listed items. It will be further understood that the terms “includes,” “including,” “comprises” and/or “comprising,” when used in this disclosure, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### System Overview

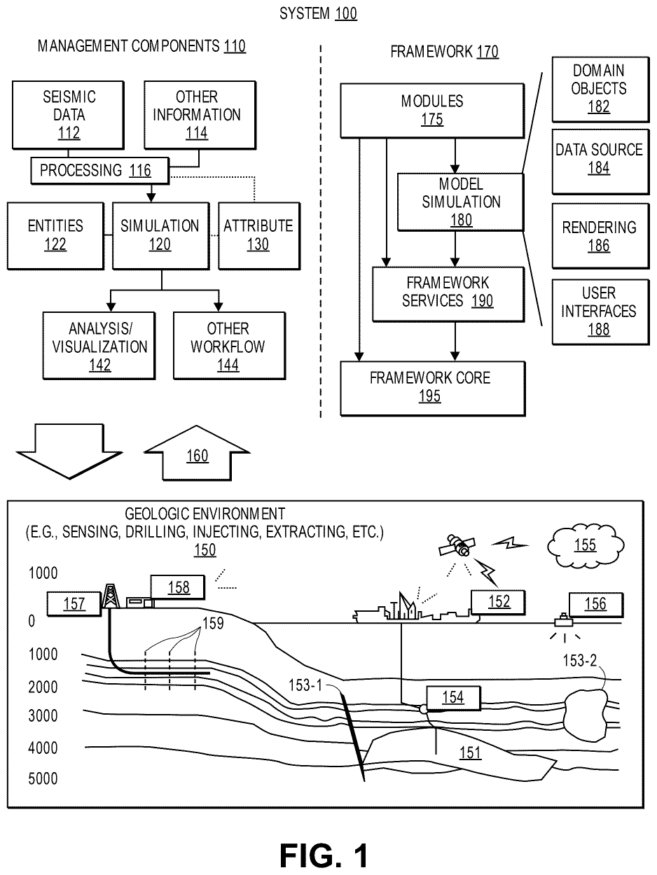

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Mode for Detecting Vibration Anomalies Using an Event Camera

The current disclosure is related to an approach for detecting equipment status and failures through the fusing of events and intensity-based camera data. The fused data may be processed through vision algorithms to detect anomalies. The anomalies may be processed to provide status and failure indications on related hardware, such as wellsite equipment disposed at a wellsite.

According to certain embodiments, a workflow is provided for determining an equipment status and fault detection through vibration measurements over the time. The workflow may fuse images provided from a neuromorphic or event camera and a standard RGB or intensity-based camera which may then be used with vision algorithms. In certain embodiments, both the event camera and the intensity-based camera may be calibrated both intrinsically and extrinsically, so that data may be associated by projecting the received event camera data onto the received intensity-based camera data. This fused data may then be coupled or used with anomaly detection algorithms, such as vibration detection workflows, that may compare live data with a baseline threshold and then trigger an alarm once that threshold has been reached.

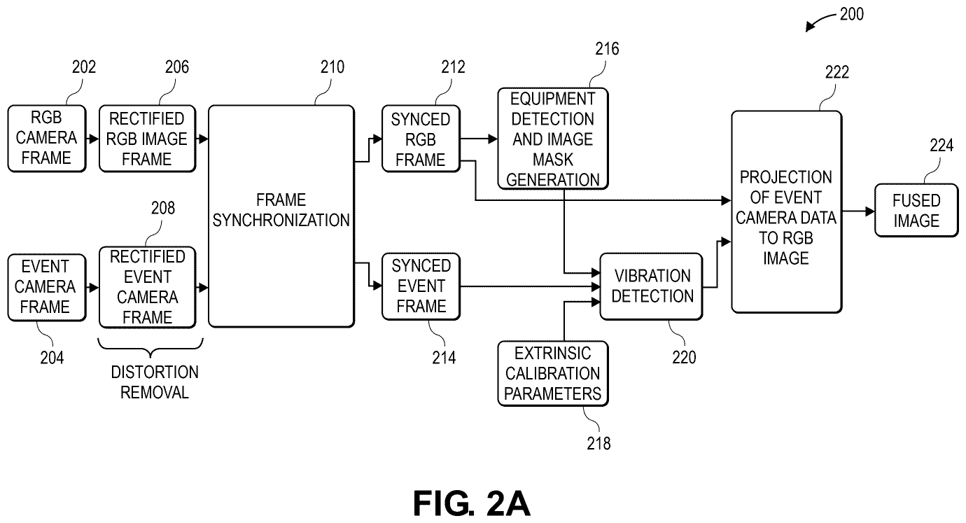

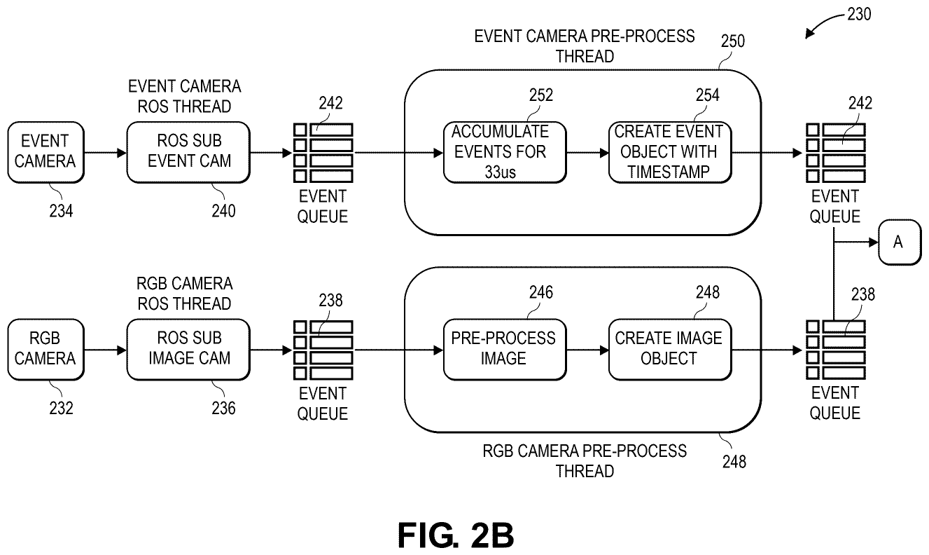

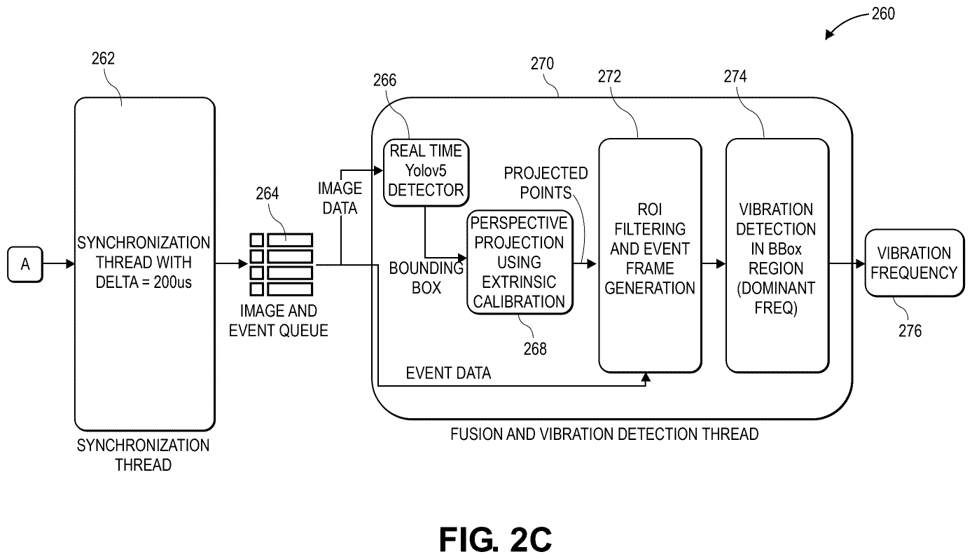

According to certain embodiments, a workflow 200 for providing a fused image may be seen in FIG. 2A. A RGB or intensity-based camera and an event camera may be disposed in or around a wellsite, the wellsite including a variety of wellsite equipment needed to operate the wellsite which may include fans, gas coolers, or any number of other tools or related equipment. The intensity-based camera and the event camera may be disposed adjacent to one another, however in certain embodiments the intensity-based camera and the event camera may be disposed at different locations in or around the wellsite. The RGB or intensity-based camera and the event camera may be positioned so as to frame or be focused on specific wellsite equipment within the wellsite.

In certain embodiments, an image frame from the intensity-based camera 202 and an image from the event camera 204 are received by a system, for example system 100 seen in FIG. 1. A time stamp may be created and then added to the image frame from the intensity-based camera 202 and the image frame from the event camera 204. Distortions, for example known distortions related to a lens which may produce unwanted bulges, image stretching, or other related image processing distortions are removed to provide a rectified intensity-based image frame 206 and a rectified event image frame 208, respectively. The rectified intensity-based image 206 and rectified event image frame 208 may then undergo frame synchronization 210 to provide a synched intensity-based frame 212 and a synched event frame 214. As used herein, “event frame” may refer to frames that are generated from continuous event streams provided from the event camera 204. In certain embodiments, event frames may be based on batches of events of either fixed size or fixed time windows which are then further processed to extract event frequency and rendered onto a frame. In certain embodiments, the rectified intensity-based image 206 and rectified even image frame 208 may each include a respective time code or time stamp which may be matched with one another to within a specified or predetermined range to provide the synched intensity-based and event frames 212, 214. In certain embodiments, the specified range may be a difference of 200 micro-seconds. For example, if the rectified intensity-based image frame 206 and the rectified event image frame 208 have time stamps which are 200 micro-seconds apart or less, the images may be considered as “synched” and are then labeled as the synched intensity-based and event frames 212, 214, respectively.

In certain embodiments, the synched intensity-based frame 212 may undergo equipment detection and image mask generation, as at step 216. In certain embodiments, equipment detection may be used to detect the specific wellsite equipment that may be presented within the synched intensity-based frame as at step 216. In certain embodiments, detection or identification of the wellsite equipment may done using a neural network configured for object detection such as YOLO or any other suitable object detection tool using machine learning, namely COCO and a hardware accelerator or the like. Additionally, an image mask or bounding box may be placed around the selected or detected wellsite equipment at step 216, both to highlight and isolate the wellsite equipment while also removing any background or extraneous noise outside of the bounding box that may be present within the synched intensity-based frame 212. Alternatively, in certain embodiments the image mask or bounding box may be placed around the wellsite equipment before any noise is removed from the synched intensity-based frame 212, thereby making subsequent detection or identification of the wellsite equipment easier.

According to certain embodiments, extrinsic calibration parameters at step 218 may be taken into account or compensated for by the workflow 200. For example, while in certain embodiments the intensity-based camera and the event camera may be adjacently disposed to one another, the intensity-based camera and the event camera may be disposed at slightly different angles, or orientations with respect to the surrounding 3D environment, namely the wellsite being captured by the respective intensity-based and event cameras. In step 218, the relative angles between the cameras, along with any other extrinsic parameters are compensated for to produce as uniform an image as possible.

In certain embodiments, the results of the extrinsic calibration parameters step 218 and the equipment detection and image mask generation step 216 are combined with the synched event frame 214 to undergo a vibration detection as at step 220. In certain embodiments, vibration detection 220 includes continuously monitoring a change in light within the bounding box of the synched event image frame 214. If the change in light within the synched image frame exceeds a predetermined threshold, a vibration event is deemed likely and an alarm is sounded. In certain embodiments, the alarm may be a visual or an audible alarm which may be activated at the wellsite, alerting wellsite workers within the area. In certain embodiments, the alarm may be displayed on a screen or other display associated with a user who may then notify a vibration specialist or other appropriate entity. Additionally, the alarm and a related description may be generated and then uploaded to a network or fleet management system in which the wellsite forms a part, thereby alerting every appropriate entity within the fleet management system. In certain embodiments, the fleet management system may include cloud based management software, for example OptiSite™ or other related platforms.

The synched event frame 214 which includes results of the vibration detection 220, may then be projected onto the synched intensity-based frame 212 at step 222. The results of projection produce a fused image 224, which includes both the image data of the synched intensity-based frame 212 and the synched event frame 214. In certain embodiments, the fused image 224 includes data related to vibration detection 220 from the synched event frame 214, and the wellsite equipment that was detected or identified in the synched intensity-based frame 212. In certain embodiments, in addition to or instead of detecting vibrations within the wellsite equipment, vibration detection 220 may further include detection or measurement of RPM of rotating wellsite equipment, for example fans and the like.

In certain embodiments, the workflow 200 may include a data acquisition phase 230 as seen in FIG. 2B, followed by a data fusion phase 260 as seen in FIG. 2C.

According to certain embodiments, in the data acquisition phase 230 seen in FIG. 2B, images from a intensity-based or RGB camera 232 and images from an event camera 234 disposed at the site are received by a system, for example system 100 seen in FIG. 1. The images from the intensity-based camera 232 may be directed through a robotic operation system (ROS) sub routine 236 and then placed in an image queue 238. The images from the event camera 234 may in turn be directed through a corresponding ROS sub routine 240 and then placed in an event queue 242.

Images within the image queue 238 may then undergo an intensity-based camera pre-processing thread 244 where the intensity-based images may be pre-processed 246 and undergo object creation 248. For example, the intensity-based images may have had distortions related to a lens which may produce unwanted bulges, image stretching, or other related image processing distortions removed therefrom. Once pre-processed, the intensity-based images may be returned to the image queue 238.

Similarly, images within the event queue 242 may undergo an event camera pre-processing thread 250 where events may be detected and accumulated over a series of the event images 252, the accumulated images being given a time stamp which corresponds to the time that the event took place 254. For example, an event such as a change in detectable light at the site may be detected and then recorded when the event has been detected over a predetermined duration, for example 30 micro seconds. The series of event images corresponding to the detected event may then be issued a time stamp. Once pre-processed, the event images may be returned to the event queue 242.

After passing the through the data acquisition phase 230, the images from the image queue 238 and the event queue 242 may be passed to the data fusion phase 260. In certain embodiments, the images may then undergo frame synchronization 262 to provide a synched intensity-based frame and a synched event frame. In certain embodiments, the intensity-based images and event images may be matched with one another to within a specified or predetermined range to provide the synched intensity-based and event frames. In certain embodiments, the specified range may be a difference of 200 micro-seconds. For example, if the intensity-based images and the event images have time stamps which are 200 micro-seconds apart or less, the images may be considered as “synched” and are then deposited into an image and event queue 264.

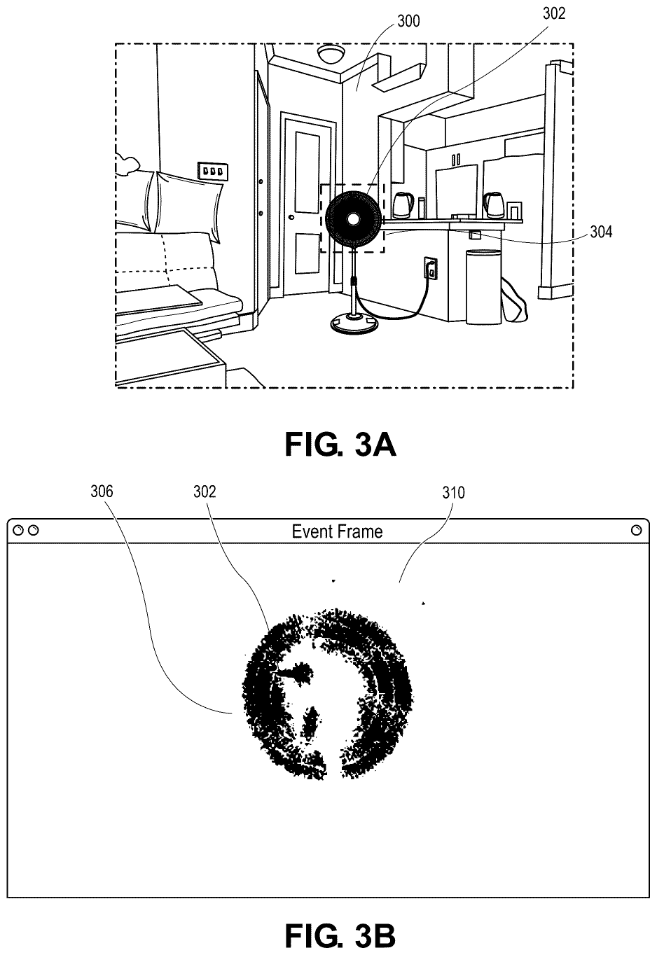

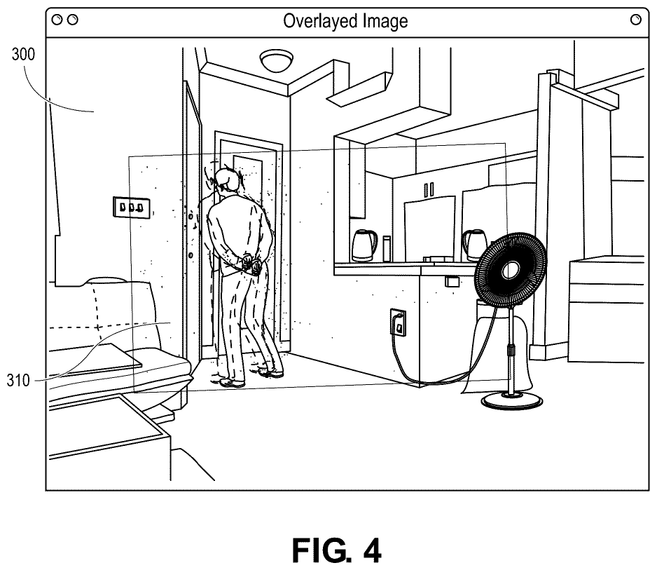

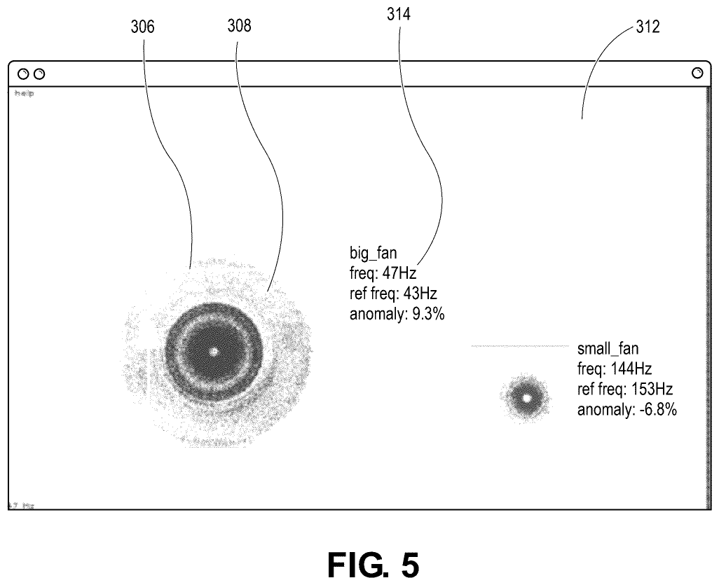

In certain embodiments, image data from the image and event queue 264 may proceed through a fusion and vibration detection thread 270. In certain embodiments, the image data may first undergo equipment detection and image mask generation, as at step 266. For example, as seen in FIG. 3A, an object 302 may be detected within the image data 300, while the same object 302 may be detected within the event data 310. In certain embodiments, equipment detection may be used to detect the specific wellsite equipment that may be presented within the image data 300. In certain embodiments, detection or identification of the wellsite equipment may done using a neural network configured for object detection such as YOLOv5. Additionally, an image mask or bounding box 304, 306 may be placed around the selected or detected wellsite equipment at step 268 in the image and event data respectively, thereby creating a region of interest (ROI). In certain embodiments, step 268 also includes perspective projection using calibration as seen in FIG. 4 where the event data 310 may be overlaid the top of the image data 300 and then compensated for so that the event data 310 and image data 300 match or align as closely as possible. Returning to FIG. 2C, the ROI defined by the bounding box within the image data may then be combined with event data from the image and event queue 264 and undergo filtering and event generation, as at step 272 to remove any background or extraneous noise outside of the bounding box that may be present within the image data. Vibration detection may then take place within the region defined by the bounding box as at step 274. For example, as seen in FIG. 5, when the amount of light detected within the bounding box 306 changes, that change may be displayed as a vibration or vibrational data 308 on a display 312. Additionally, an information suite 314 may be displayed adjacent to the bounding box 306, the information suite 314 providing a meaningful visual reporting of the current status of the wellsite equipment. The information suite 314 may include but is not limited to displaying labels, vibration frequency, a reference vibration frequency, and an estimated percentage that an anomaly is occurring within the wellsite equipment. Returning to FIG. 2C, the detected vibration frequency 276 may then displayed as output, for example as a fused image including vibration detection data.

### Exemplary Workflow

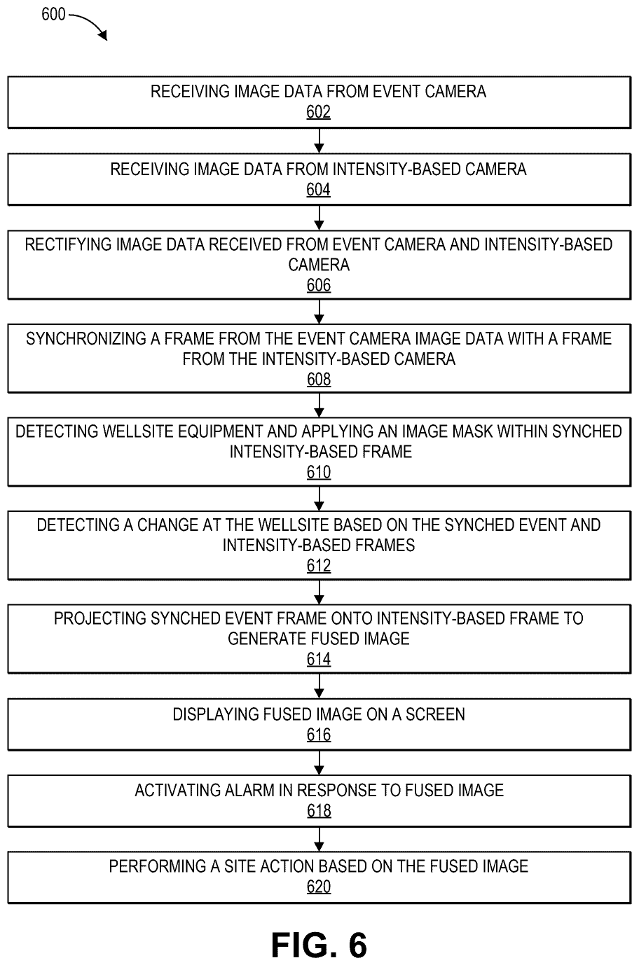

FIG. 6 provides an exemplary detailed workflow 600 for determining equipment status and detecting faults through vibration measurements over time at a wellsite. The method may include generating first image data from an event camera event stream disposed at the site e, as at 602, and receiving image data from an intensity-based camera disposed at the wellsite, as at 604.

According to certain embodiments, the workflow 600 may include rectifying the image data received from the event camera and the intensity-based camera and providing a rectified event frame and a rectified intensity-based frame, respectively, as at 606. Rectifying the image data may include removing a distortion from the image data received from either the event camera or the intensity-based camera. In certain embodiments, step 606 may also include calibration of the image data, for example resizing and/or clipping data received from each camera so that they match or represent a field of view in which bounding boxes may be defined around the same objects.

In certain embodiments, the workflow 600 includes synchronizing a frame from the event camera image data with a frame from the intensity-based camera image data, as at 608. The frame from the event image data may be synchronized with the frame from the intensity-based image data when a time stamp of the event frame and the intensity-based frame are within a predetermined range of each other. In certain embodiments, the predetermined range may be 200 micro-seconds or less.

In certain embodiments, the workflow 600 may further include detecting wellsite equipment within the synched intensity-based frame and applying an image mask to the detected wellsite equipment within the synched intensity-based frame, as at 610.

According to certain embodiments, the workflow 600 includes detecting a change at the wellsite based on the synched event and intensity-based frames, as at 612. Detecting the change at the wellsite based on the synched event and intensity-based camera may include detecting a vibration within wellsite equipment disposed at the wellsite, which in turn may include detecting a change in light within the synched intensity-based frame.

In certain embodiments, the workflow 600 includes projecting the synched event frame onto the intensity-based frame to generate a fused image, as at 614. The detected change at the wellsite from the synched event frame may be projected onto wellsite equipment that has been detected within the intensity-based frame. The workflow 600 may then include displaying the fused image on a screen, as at 616.

In certain embodiments, the workflow 600 also includes activating an alarm at the wellsite based on the detected change, as at 618. Activating the alarm may include displaying the alarm on the screen, actuating an alarm disposed at the wellsite, or transmitting the alarm to a network communicated to the wellsite.

According to certain embodiments, the workflow also includes performing a site action based on the fused image on the screen, as at 620. Performing the site action may include generating or transmitting a signal that instructs or causes an action to occur. The action may include a physical action. The physical action may include addressing an activated alarm, deactivating equipment at the wellsite, adjusting the equipment at the wellsite, monitoring the equipment at the wellsite, repairing the equipment at the wellsite, or a combination thereof.

### Exemplary Computing System

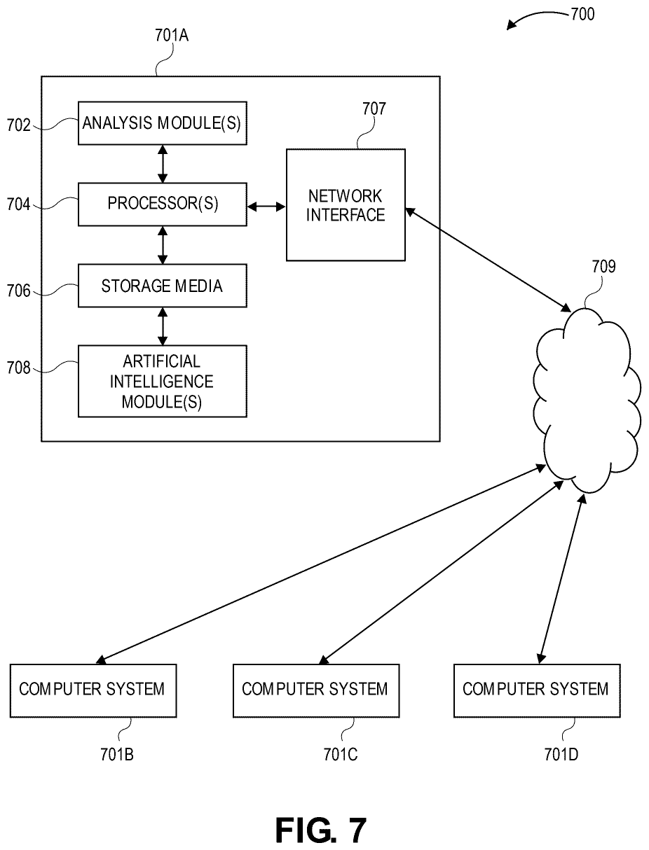

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the risk index.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of this disclosure.

Of course, many processing techniques for collected data, including one or more of the techniques and methods disclosed herein, may also be used successfully with collected data types other than seismic or other subsurface modeling data. While certain implementations have been disclosed in the context of seismic or other subsurface data collection and processing, those with skill in the art will recognize that one or more of the methods, techniques, and computing systems disclosed herein may be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Some examples of equations and mathematical expressions may have been provided in this disclosure. But those with skill in the art will appreciate that variations of these expressions and equations, alternative forms of these expressions and equations, and related expressions and equations that may be derived from the example equations and expressions provided herein may also be successfully used to perform the methods, techniques, and workflows related to the embodiments disclosed herein.

The foregoing description, for purposes of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to explain the principles of this disclosure and its practical applications, to thereby enable others skilled in the art to use the disclosed approach and various embodiments with various modifications as are suited to the particular use contemplated.

What is claimed is:

1. A method for determining equipment status and detecting faults through vibration measurements over time at a site, the method comprising:
generating first image data from an event camera event stream disposed at the site;
receiving second image data from an intensity-based camera disposed at the site;
synchronizing a frame from the first image data with a frame from the second image data to produce first and second synchronized frames;
detecting a change at the site based on the synchronized first image data and second image data;
projecting the first synchronized frame onto the second synchronized frame to generate a fused image; and
displaying the fused image on a screen.

2. The method of claim 1, wherein detecting the change at the site based on the synchronized first and second image data comprises detecting a vibration within equipment disposed at the site.

3. The method of claim 2, wherein detecting the vibration within equipment disposed at the site comprises comparing the detected vibration to a predetermined vibration threshold.

4. The method of claim 3, further comprising activating an alarm when the detected vibration has exceeded the predetermined vibration threshold.

5. The method of claim 4, wherein activating the alarm comprises:
displaying the alarm on the screen;
actuating an alarm disposed at the site; or
transmitting the alarm to a network communicated to the site.

6. The method of claim 1, further comprising removing a distortion from either the first or second image data.

7. The method of claim 1, further comprising detecting equipment within the second synchronized frame.

8. The method of claim 7, further comprising applying an image mask to the detected site equipment within the second synchronized frame.

9. The method of claim 1, further comprising compensating for extrinsic calibration parameters present between the event camera and the intensity-based camera.

10. The method of claim 1, further comprising performing a site action based on the fused image on the screen.

11. A computing system, comprising:
one or more processors;
a memory system comprising one or more non-transitory computer-readable media storing instructions that, when executed by at least one of the one or more processors, cause the computing system to perform operations, the operations comprising:
generating first image data from an event camera event stream disposed at a site;
receiving second image data from an intensity-based camera disposed at the site;
synchronizing a frame from the first image data with a frame from the second image data to produce first and second synchronized frames;
detecting a change at the site based on the synchronized first image data and second image data;
projecting the first synchronized frame onto the second synchronized frame to generate a fused image; and
displaying the fused image on a screen.

12. The computing system of claim 11, wherein the operations further comprise rectifying the first and second image data to produce first and second rectified frames.

13. The computing system of claim 12, wherein the first and second image data to produce first and second rectified frames comprises removing image processing distortions related to a lens of either the event camera or the intensity-based camera.

14. The computing system of claim 11, wherein the operations further comprise adding a time stamp to the first and second image data.

15. The computing system of claim 14, wherein synchronizing the frame from the first image data with the frame from the second image data comprises synchronizing the frame from the first image data with the frame from the second image data when the time stamps of the frame from the first image data and the frame from the second image data are within a predetermined range.

16. The computing system of claim 15, wherein the predetermined range is less than 200 micro-seconds.

17. The computing system of claim 11, wherein projecting the first synchronized frame onto the second synchronized frame to generate the fused image comprises projecting the detected change at the site from the first synchronized frame onto site equipment detected within the second synchronized frame.

18. The computing system of claim 17, wherein the operations further comprise placing an image mask configured to remove background noise around the site equipment within the fused image.

19. The computing system of claim 11, wherein the operations further comprise performing a site action based on the fused image, wherein performing the site action comprises generating or transmitting a signal that instructs or causes an action to occur, wherein the action comprises a physical action, and wherein the physical action comprises addressing an activated alarm, deactivating equipment at the wellsite, adjusting the equipment at the wellsite, monitoring the equipment at the wellsite, repairing the equipment at the wellsite, or a combination thereof.

20. A non-transitory computer-readable medium storing instructions that, when executed by one or more processors of a computing system, cause the computing system to perform operations, the operations comprising:
generating first image data from an event camera event stream disposed at a site;
receiving second data from an intensity-based camera disposed at the site;
synchronizing a frame from the first image data with a frame from the second image data;
detecting a change at the site based on the synchronized first image data and second image data;
projecting the first synchronized frame onto the second synchronized frame to generate a fused image; and
displaying the fused image on a screen.
